(19) United States
(12) Patent Application Publication
(10) Pub. No.: US 2003/0169692 A1
(43) Pub. Date: Sep. 11, 2003

(54) System and method of fault restoration in communication networks

(76) Inventors: Thomas E. Stern, Riverdale, NY (US); Aklilu Hailemariam, Toms River, NJ (US)

Correspondence Address: DARBY & DARBY P.C., Post Office Box 5257, New York, NY, 10151-5257, US

(21) Appl. No.: 10/337,241

(22) Filed: Jan. 6, 2003

Related U.S. Application Data
(63) Continuation-in-part of application No. PCT/US02/17745, filed on Jun. 5, 2002.
(60) Provisional application No. 60/296,277, filed on Jun. 5, 2001.
(60) Provisional application No. 60/309,992, filed on Aug. 3, 2001.

(51) Int. Cl. H04L 1/00

(52) U.S. Cl. 370/242; 370/248

(57) ABSTRACT

A method and system is described for the restoration of communications in a communication network upon the detection of a perceived fault. The system is able to restore a fault without the node detecting a perceived link fault knowing whether the actual fault is on the link or the node attached to the other end of the link. Upon fault detection, the system reroutes communications affected by the fault onto predefined restoration paths by reconfiguring the cross-connects in the network nodes. Each restoration path is restricted to an island which is a prescribed sub-network made up of nodes and links surrounding the fault.

### CROSS-REFERENCE TO RELATED APPLICATIONS

This application is a continuation-in-part of International Patent Application No. PCT/US02/17745, entitled A SYSTEM AND METHOD OF FAULT RESTORATION IN COMMUNICATION NETWORKS, filed on Jun. 5, 2002, which claims priority to U.S. Provisional Patent Application No. 60/296,277, entitled A METHOD OF FAULT RESTORATION IN COMMUNICATION NETWORKS, filed on Jun. 5, 2001 and also claims priority to U.S. Provisional Patent Application No. 60/309,992, entitled A METHOD OF FAULT RESTORATION IN COMMUNICATION NETWORKS, filed on Aug. 3, 2001, the disclosures of which are incorporated herein by reference in their entirety.

### FIELD OF THE INVENTION

This invention relates generally, to restoration methods in communication networks and more particularly, to restoration methods which compensate for link and node failures experienced across a communication network.

### BACKGROUND OF THE INVENTION

Communication networks handle various types of data traffic at data speeds which increase daily. Communication networks carry data, text, voice, image and video at individual channel speeds of gigabits/sec. Often times, one communication link single handedly accommodates hundreds of these channels. As such, protection schemes must be developed to restore traffic affected by failures of network elements including links and nodes. To be robust, a restoration/protection scheme takes into consideration restoration speed, restorability, and capacity efficiency. A further description of these characteristics follows.

First, restoration speed determines the amount of time necessary to recover from a fault. Restoration speed is of the utmost importance for some types of services wherein a delay in recovery could have serious adverse effects on the users of the communication network. For example, in financial and public safety applications an excessive delay in recovering from a failure could prove disastrous. Second, restorability is the ability to recover from various types and combinations of faults. Such faults can include, but are not limited to link and node failure. Link failure is more common than node failure. However, fire, flood, war and/or other catastrophes could easily cause a complete node failure. Node failure incapacitates not only all the node's equipment, but also all links incident on that node. Partial node failure also occurs. Such a node failure could be caused by a partial equipment failure within a node, such as the failure of a switch or the link terminating equipment. Examples of link terminating equipment can include, but are not limited to transmitters and receivers and multiplexers and demultiplexers. Complete network node failure, the most catastrophic, results in all the signals arriving at a node being lost. Grades of restorability are also of interest for different classes of traffic demands. Thus, some demands might be protected against both link and node failure, while other demands may be protected against link failure only. Third, efficient use of network capacity is of concern. Capacity efficiency is high when the fraction of total network capacity reserved for fault restoration is low. Thus, high capacity efficiency results in a more economical use of the network infrastructure.

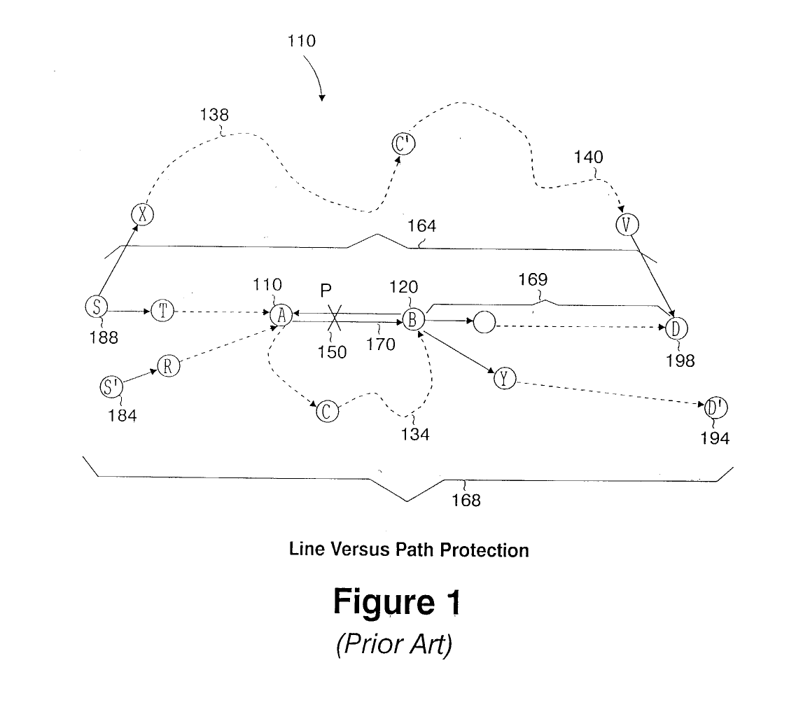

Two prior art approaches to network protection and network restoration are line protection and path protection. Line protection is fast and implemented easily. However in mesh networks, i.e. networks with complex connectivity patterns, line protection does not compensate for node failure. Path protection can be used to compensate for both link and node failures. However, path protection is relatively slow and involves complex protocols and extensive signaling. Consequently, path protection is less reliable than line protection. In line protection, the nodes at each end of a failed link sense a fault. A node may sense a link fault by detecting a loss or degradation of the communication signal. Once the node senses the fault, the node detours all traffic on the failed link onto a predetermined restoration path reserved for link failure. This is illustrated in FIG. 1, where the link 170 between node A 110 and node B 120 is broken at point p, the fault 150, and traffic originating at source S 188 and source S′ 184 is detoured around the fault 150 via the predetermined restoration path 134 through node C and then back to node B 120 to continue on its original paths to the destination node D 198 and destination node D′ 194. In a high capacity network, many source-destination connections, carried on different channels, pass through link 170 between node A 110 and node B 120. All the various source-destination connections are detoured using the same restoration path 134 regardless of their source 184, 188 or destination nodes 194, 198. As illustrated, line protection focuses only on the fault 150. Consequently, line protection is oblivious to individual connections between source and destinations nodes carried by the link 170. While line protection is fast and simple, a disadvantage of line protection is that it cannot deal with node failure. For instance, if node A 110 or node B 120 fails, line protection cannot restore the traffic carried by the node.

In path protection, each active connection in the network has a working path, which is used when all equipment is functioning normally, and each working path is paired with a predetermined restoration path, to which the traffic is switched when any network element along the working path fails. For example in FIG. 1, two working paths, S-D 164 and S′-D′ 168 are shown. The working path S-D 164 from source S 188 to destination D 198 is restored via the restoration path 138 traversing node C′. (The restoration path for working path S′-D′ 168 is not shown.) The restoration path in this case is link- and node-disjoint from its working path (except for the end nodes). A restoration path that is link-disjoint, but not node-disjoint from its working path protects only against link failure. As illustrated, the restoration path, being both link- and node-disjoint, insulates the working path 164 from both link and node failures.

Using path protection each working path needs a restoration path, and all restoration paths need reserved capacity. Assuming that only one network element fails at a time, the restoration capacity reserved on a given link can be shared among several working paths if those working paths don't use the same links or nodes. This ensures that if one link or node fails, restoration capacity will always be available to restore all working paths that use the failed equipment. Path protection can compensate for both link and node failure, and utilizes capacity efficiently (under the assumption that care is taken to optimize all working and restoration paths), but path protection is a slow and complex operation because restoration cannot occur until both the source and destination nodes of each connection affected by a fault and all nodes on the connection's restoration path know that a fault has occurred somewhere on the connection's working path.

In FIG. 1, for example, with path protection when link 170 between node A 110 and node B 120 fails, failure messages must be sent first via the downstream working path 169 from node B 120 to the destination node D 198 and then upstream from node D 198, along the restoration path 100, to the source node S 188 before any restoration efforts begin. A similar operation must be executed independently and simultaneously for each connection carried on the failed link, for example, the connection from node S′ 184 to node D′ 194.

Accordingly, it would be advantageous to provide an improved fault restoration technique and method combining the best features of line and path protection with a simple design that is fast and easily implemented.

### SUMMARY OF THE INVENTION

The present invention is directed to a system and method of communication restoration in communication networks which successfully restores failures without knowing whether they are link faults or node faults, and which confines its restoration paths to a limited neighborhood of the fault.

In accordance with a first embodiment of the present invention is a method for fault restoration of communication connections upon detection of a perceived link fault in a communication network. The communication network comprises a set of nodes and a set of links connecting those nodes. At least one node of the set of nodes being a source node for a communication connection and at least one node of the set of nodes being a destination node for a communication connection. In addition, at least two nodes contain a controllable cross-connect for routing communication connections through the node. First, islands consisting of subnetworks surrounding each node are identified so as to define a circumscribed domain for restoration paths for communication connections using the node in case of a failure of that node or one of its attached links. Second, restoration routing tables are stored in the nodes containing the information necessary to restore each affected communication connection when a fault occurs. Each restoration path has the capacity needed to support the communication connection it is restoring. Third, the required restoration capacity is reserved on each link for each predetermined restoration path using that link in the event of an actual fault. Finally, a communication connection is restored when a node perceives a link fault and initiates the restoration process. A node perceives a link fault by sensing a loss or degradation of a signal on one of its attached links. However, while the signal loss is perceived as a link fault, the actual fault may be on the link or in the node attached to the other end of the link. The restoring step proceeds successfully in absence of knowledge of whether the actual fault is on the link or the node attached to the other end of the link. Restoration is effected by reconfiguring the cross-connects according to information stored in the routing tables.

In accordance with another embodiment of the present invention is a system for communication restoration in a communication network upon detection of a perceived fault. The system comprises a plurality of communication nodes, communication links and communication devices. Each node is connected to at least one other node by a communication link. Each link supports at least one channel in each direction. The channel is supported by a transmission facility in each direction on the link. At least two of the devices are connected to or incorporated in respective nodes. At least one node acts as a source of a communication connection for a device associated with the node, and at least one node acts as a destination of a communication connection for a device associated with the node. In addition, at least two of the nodes contain (a) a restoration subsystem for restoring communication connections upon perceived link failure and (b) a controllable cross-connect. The cross-connects have at least two input ports and two output ports. The channels connect to the input ports and the output ports of the cross-connects. The restoration subsystem for restoring communication connections: (1) detects perceived faults on the links attached to its nodes, (2) stores information related to fault restoration, and (3) exchanges information between nodes for executing fault restoration procedures.

In the system, at least one node triggers a fault restoration procedure once the restoration subsystem in that node detects a perceived link fault. The fault restoration procedures of the system: (1) reconfigure the controllable cross-connects to detour communication connections affected by the fault using predetermined restoration paths on links confined to a prescribed island of each perceived fault, the island being a prescribed sub-network of the communication network containing the perceived fault and (2) restore communication connections carried by the link perceived to have failed without the node detecting the perceived link fault having knowledge of whether the actual fault is on the link or the node attached to the other end of the link.

### BRIEF DESCRIPTION OF THE PREFERRED EMBODIMENTS

The foregoing and other features of the present invention will be more readily apparent from the following detailed description and drawings of illustrative embodiments of the invention in which:

FIG. 1 depicts prior art line and path protection schemes;

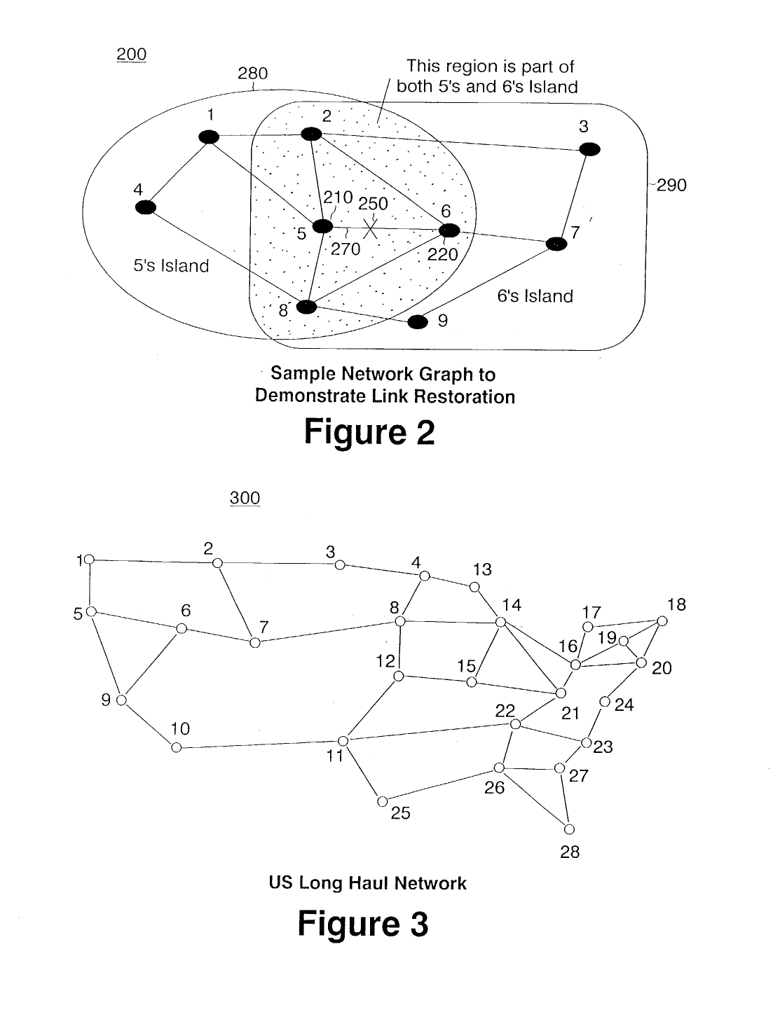

FIG. 2 depicts an exemplary illustration of the island restoration technique in accordance with the present invention;

FIG. 3 depicts an exemplary communication network employing the island restoration technique in accordance with the present invention;

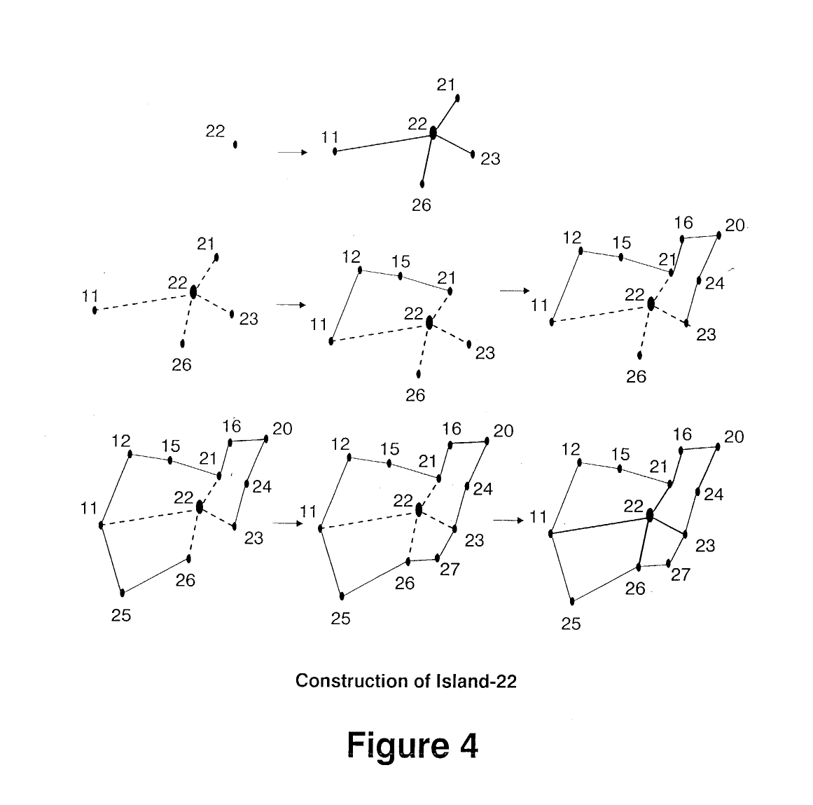

FIG. 4 depicts the construction of island twenty-two based on the communication network depicted in FIG. 3;

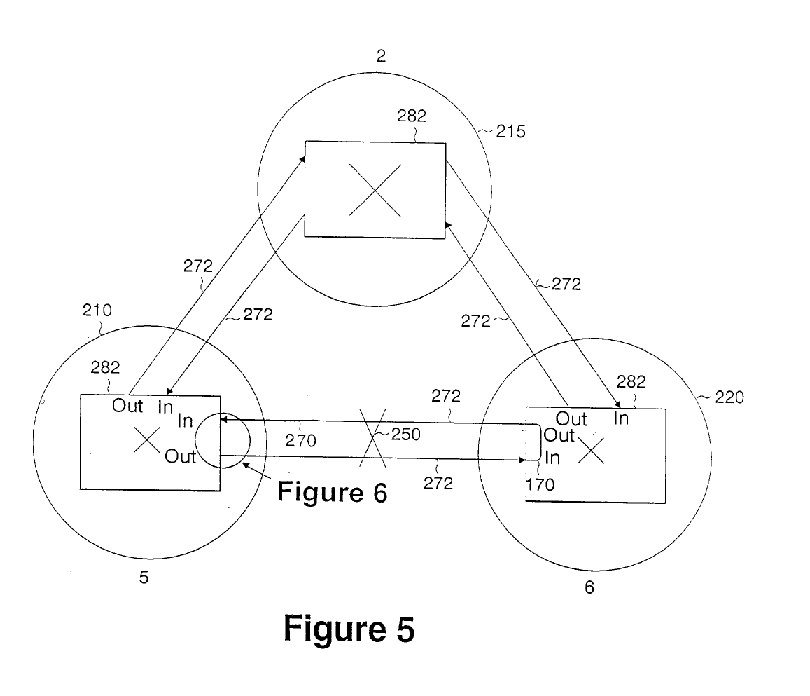

FIG. 5 depicts a detailed view of node two, node five and node six of FIG. 2; and

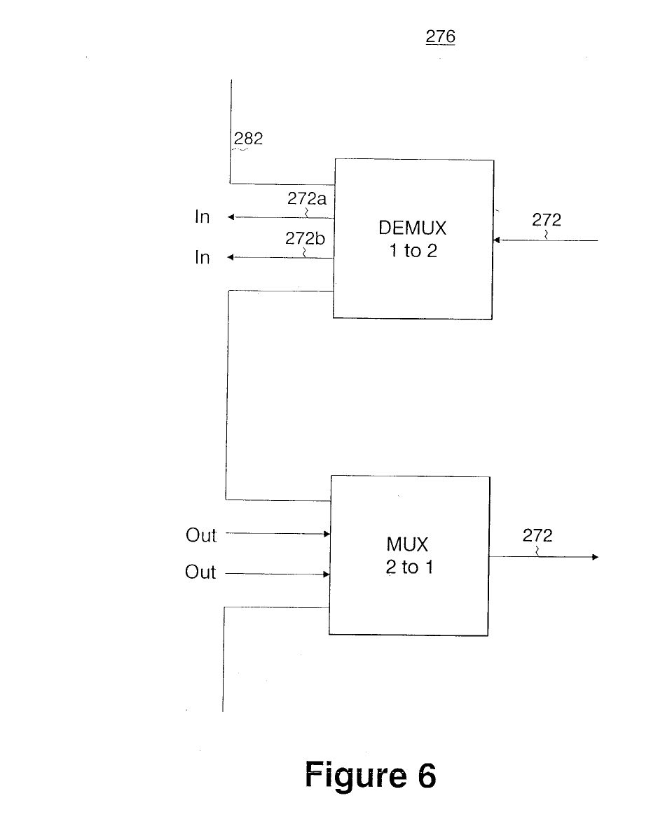

FIG. 6 depicts a detailed view of the cross connect of node five depicted in FIG. 5.

### DETAILED DESCRIPTION OF THE PREFERRED EMBODIMENTS

By way of overview, restoration subsystems in the nodes in the network of the present invention detect perceived link faults and reroute individual communication connections around the perceived fault by reconfiguring their cross-connects. If a node detects a perceived link fault the actual fault may be on the link or on the node attached to the other end of the link. The system reroutes the communication connections on predefined restoration paths confined to predefined islands that localize the restoration paths. The system detours communications around the fault upon fault perception, successfully accomplishing fault restoration without requiring knowledge of whether the actual fault is on a link or a node. The restoration subsystem needs only to detect the actual fault directly or indirectly by sensing signals on its attached links.

The identification of overlapping sub-networks, or in other words islands, which localize all restoration operations is just one feature unique to the method and system of the present invention. The method confines restoration to the immediate neighborhood or in other words the island surrounding the failure. Consequently, the present invention significantly reduces the time delays associated with restoration, thus improving restoration speed and producing restoration delay times considerably less than in path protection and comparable to line protection. Furthermore, the complexity and communication burden of the restoration signaling protocols is significantly less than in path protection. The restoration procedure in response to a fault is exactly the same whether the actual fault is on a link or a node, so that the system for restoration is applicable to both link and node failures—an improvement over line protection. With the present invention, capacity efficiency is comparable to path protection, because restoration capacity is shared among overlapping network islands. The reserved capacity can also be used for low priority pre-emptible traffic when it is not being used for restoration. Finally, multiple failures can be simultaneously restored provided that the restoration resources required for each failure are mutually disjoint.

While the method is presented here in the context of a multi-wavelength optical fiber network, the present invention is adaptable to any other type of communication network such as, but not limited to, copper wire and free space communication networks. The original network protected by the restoration scheme is covered by overlapping sub-networks or islands for the purposes of restoration. For a network with a given number (“N”) of nodes, N islands are formed wherein the node at each island's center is called the island node. Each island is a sub-network of the original network. Islands are constructed beginning with the island nodes, then with the links incident to the island nodes, and finally with additional links and nodes as required. Island nodes identify islands by name. Islands localize restoration procedures for failures of the island nodes and their incident links by rerouting affected traffic using restoration paths confined to the island. Island identification is an off-line procedure, executed during network planning, and occasionally updated when network topology changes.

Aside from island node and incident links, the remaining island components are chosen in light of desired performance criteria. At a minimum, each island must have the property that the island remains connected when the island node and incident links are removed; i.e., each remaining node in the island has a path within the island to every other node in the island. Otherwise, it will not be possible to restore all affected traffic via restoration paths confined to the island in the case of failure of the island node. For some network topologies it may be impossible to construct an island around every node having the required connectivity property. For example, it may be that the removal of a given node and its incident links breaks the network into two separate parts. In that case the network is not survivable, because it is impossible to restore any demand whose source is in one of the two separate parts and whose destination is in the other, no matter what restoration procedures are used. Henceforth, it will be assumed that the networks being considered are survivable, so that it is always possible to construct islands around every node with the required connectivity property.

A given network's desired restoration capabilities will dictate island size. It can be either a set of links which satisfies the minimum connectivity requirement, or it can be expanded with additional nodes and links. The advantage of the minimal set is that restoration routes are generally short, computation and restoration execution is simplified, and restoration speeds are high. On the other hand, a larger island offers more flexibility in choosing restoration paths to meet various other performance criteria, such as maximum capacity efficiency or uniform link loading. If the island size is unlimitedly expanded, each island would include the whole network, giving maximum flexibility in the choice of restoration paths, but slowing down the restoration process and increasing its complexity.

The network links of the present invention contain transmission facilities (assumed here to be bi-directional), which could be copper wires, optical fibers, free space or any other communication medium. These transmission facilities are typically of very high capacity, in which case they are normally “channelized” into lower capacity basic communication channels allocated to individual user connections. These channels are then aggregated into high speed data streams for transmission on the link using various multiplexing techniques; e.g., time, frequency and/or wavelength division multiplexing. The network nodes contain the cross-connect, transmission, multiplexing and ancillary equipment necessary to create end-to-end connections between equipment accessing the network. In the case where wavelength division multiplexing us used on the links, the network nodes are assumed to contain wavelength conversion equipment allowing an end-to-end path to use different wavelengths on different links.

The communication devices accessing the network at each node are the source and destination of the various data streams carried through the network. A demand is created by two users accessing the network at a pair of nodes and requiring a connection. A communication connection or more briefly a connection, satisfying a given demand is created along an end to end working path in the network through the action of cross-connects, also called switches, in the nodes, which cross-connect individual channels on the links to form a continuous communication path between the source and destination of the connection. The capacity, i.e. the number of channels, allocated to the connection must be adequate to satisfy the demand. While it will usually be assumed that demands are bi-directional, requiring the same capacity in both directions, the invention is adapted to unidirectional demands as well. It is assumed throughout that each demand requires and is allocated either one unit of capacity, corresponding to the capacity of one basic channel, or some multiple of the basic unit, provided by a combination of several basic channels on each link in its end-to-end path.

FIG. 2 depicts an exemplary illustration of the present invention's technique, showing a nine node network 200 and two of its islands. In FIG. 2, island five 280 includes the node set {4,1,2,5,6,8} and all links of the network 200 which are incident on any pair of these nodes. As shown in FIG. 2, island five 280 contains perimeter nodes {1,2,6, 8, 4} which become a border around node five 210 and determine a boundary for island five 280. In this case, the island is not minimal, since it would still fulfill the connectedness requirement if node four and its incident links were not included. In this example, a connection is active from source node one to destination node eight via the working path 1-5-8. If node five 210 fails a restoration path 1-4-8 is reserved within island five 280 to detour the connection around the failed node, resulting in a new source to destination path 1-4-8. If island five 280 were reduced to its minimal form by removal of node four, the connection would have to be detoured around node five using the restoration path 1-2-6-8, which is longer, (three hops instead of two) and hence less desirable than the restoration path used in the larger island containing node four. Reducing hops reduces restoration time and network congestion. A hop as used herein refers to the movement from one node to an adjacent node. In this example, path 1-2-6-8, is 3 hops because data moves first from node one to node two, second from node two to node six and third from node six to node eight.

FIG. 5 depicts a detailed view of the node five 210, node two 215, and node six 220 portions of the exemplary illustration of the present invention. As shown in FIG. 5, the link 270 is comprised of two unidirectional transmission facilities 272 traversing the link 270 in opposite directions. In other words, the link is comprised of a bidirectional transmission facility. Each transmission facility comprises at least one channel but may contain many channels. In the preferred implementation shown in FIG. 6, each transmission facility 272 comprises two communication channels 272a, 272b. Each node comprises a controllable cross-connect 282 which, in times of normal network operation is set to route connections on working paths through its incident links. However, in times of a perceived link failure the cross-connect may be reconfigured to detour active connections traversing the link perceived to have failed onto alternative, predetermined restoration paths.

The controllable cross-connects 282 have at least two input ports and at least two output ports to which the communication channels on the transmission facilities 272 are connected. Each node also comprises a restoration subsystem. The subsystem in the node detects perceived faults on the links attached to the node, stores information related to fault restoration, and exchanges information with other nodes for executing fault restoration procedures. The fault restoration procedures reconfigure cross-connects 282 to detour communication connections affected by the fault (for example, link fault 250 in FIG. 5) using predetermined restoration paths on links confined to a prescribed island of each perceived fault.

In FIG. 5, rather than have communication connections travel along the link 270 between node five 210 and node six 220, the cross-connects 282 would detour the communication connections around the fault 250 using the predetermined restoration paths. One such restoration path could be but, is not limited to, detouring communication connections around the fault 250 by switching their path from node five 210 to node six 220 to instead pass from node five 210 to node two and from node two to node six 220. FIG. 6 further details the transmission facilities 272 of the present invention. As shown in FIG. 6, the communication channels 272a and 272b entering input ports on cross-connect 282 are demultiplexed by the box “DEMUX” from the inbound transmission facility 272. Similarly, two communication channels exiting output ports on cross-connect 282 are multiplexed by the box “MUX” onto an outbound transmission facility 272. While not shown, as the communication channels exit each output port of the cross-connect 282 of node six 220, the communication channels sharing a common outbound transmission facility are multiplexed onto that facility 272 through the use of a multiplexer similar to the multiplexer shown in FIG. 6 for the output port of the cross-connect 282 of node five 210. In addition, while not shown, the plurality of communication channels carried by each transmission facility 272 inbound to node 6 are demultiplexed by a de-multiplexer similar to the de-multiplexer shown in FIG. 6 for the input port of the cross-connect of node five 210. The demultiplexed channels are then connected to input ports on the cross-connect 282. In sum, when a transmission facility 272 contains a plurality of communication channels they enter a multiplexer (“MUX”) at output ports of a cross-connect, traverse the transmission facility in multiplexed form and enter the de-multiplexer (“DEMUX”) at the input ports of the cross-connect at the other end of the transmission facility. The combination of the MUX, DEMUX, comprise terminating equipment 276 necessary to connect the communication channels carried on the transmission facilities 272 on the link 270, to the ports on the cross-connects at each end of the link. Additional terminating equipment, including optical transmitters and receivers might be needed if, for example, the cross-connect is electrical and the transmission facilities are optical fibers.

FIG. 3 depicts an exemplary communications network according to one embodiment of the present invention. The procedure used to construct island 22 a sub-network of the network of FIG. 3 is shown in FIG. 4. In a preferred implementation the island is designed to minimize the length of all restoration paths in case of failure of the island node. As shown in FIG. 4, once the island node is picked, in this case node twenty two, the island is partially constructed using the incident links and adjacent nodes. Next, the minimum hop paths which do not traverse the island node are found between all pairs of adjacent nodes. The links and nodes used for these paths are included in the island.

In a preferred embodiment of the invention it is assumed that

(1) The network is made up of interconnected switching nodes (nodes) and transmission links (links). Communication devices serving as the source and destination of communication connections are connected to or incorporated in the nodes, and the cross-connects (switches) in the nodes serve to connect communication channels inbound to the nodes to channels outbound from the nodes under the control of a network management system, thereby creating end to end communication paths supporting connections between communication devices accessing the network through the nodes. The switches are able to connect any inbound channel to any outbound channel. Each channel has one unit of communication capacity.

(2) A signaling network exists as part of the larger network, which supports information exchange for network management and control, including fault restoration.

(3) All network demands and their capacity requirements are known and each demand has been assigned a communication connection, whose working path has been designated before the island restoration scheme is implemented.

(4) All demands are bidirectional and their connections follow the same working path in both directions.

(5) Only one network element either a link or node fails at a time. If a link fails, the link fails completely in both directions. If a node fails, the node failure is equivalent to the failure of all of the node's incident links.

(6) All nodes are equipped with restoration subsystems which comprise the fault detection, signaling, information processing and switching devices required to implement fault restoration.

(7) For purposes of failure detection, the only information a node has available to it is the state of each of its incident links. A node may detect a complete or partial failure of an incident link by monitoring signal level and/or signal quality on the link, but other methods are also possible, using, for example, auxiliary information received on a partially failed link. For the purposes of this invention it suffices that each node has at least one reliable method of detecting a perceived failure of each of its incident links.

(8) If a node perceives a failure of an incident link it is possible that the true source of the problem is the complete failure of the node at the other end of the link in question. However, no other information being available to it, a node detecting a perceived failure of an incident link will always view the problem as a failed link, and execute its restoration procedures accordingly.

(9) Sufficient spare channels are available in the network to restore any single link or node failure.

Some of these assumptions will be relaxed for other embodiments described below.

A key property of the restoration scheme described in this invention is the designation of the nodes that initiate restoration of each demand affected by a failure. To this end it is convenient to decompose each bidirectional demand into a primary and secondary unidirectional component. A unidirectional demand is designated as primary if its source node number is lower than its destination node's number. Otherwise it is designated as secondary. Primary and secondary connections are associated with the primary and secondary demands respectively. Restoration procedures begin with all primary components affected by a failure.

In a preferred embodiment of the invention restoration proceeds according to an Island Restoration Protocol, IRP, which has a preliminary part that prepares the network to respond to failures, and a real-time part, executed in response to each failure. The preliminary part consists of identifying the islands, pre-computing the restoration routes, calculating and reserving the restoration capacity required on each link, and disseminating the routing table and restoration protocol information to the applicable nodes. This information dissemination can be done via a signaling network associated with the network management system. Under assumption (3) above, all network demand information is available before this part of the IRP is implemented.

The preliminary part of the IRP uses the following rules:

(1) An island participates in a restoration process only as a result of the failure of the island node or one of its incident links.

(2) For purposes of restoration of each perceived link failure, the node sensing the failure is designated as the detecting node, (“DN”) and the node at the other end of the failed link is designated as the island node, (“IN”). Each demand whose primary component uses a working path outbound from the DN on the failed link is assigned a restoration path completely encapsulated within the restoration island. The restoration path excludes the island node unless it is the destination node for that primary demand.

(3) For bi-directional demands, the secondary component is assigned the same restoration path as the primary, in the opposite direction.

(4) Restoration capacity is reserved on each link based on the assumption that only one network element, either a link or node, fails at a time.

The real-time part of the IRP consists of the actions performed in a coordinated manner in response to a failure. It operates using restoration routing tables and protocol instructions stored in each network node and uses the following rules:

(1) A DN initiates restoration of all demands whose primary component is directed outbound from the DN on the failed link. The DN does not initiate restoration of any demands whose secondary component is directed outbound on the failed link.

(2) If a restored demand is bi-directional, the IRP restores both primary and secondary components along the same restoration path in opposite directions.

(3) If a node fails, all of its adjacent nodes become DNs for perceived link failures and initiate restoration of their primary demands independently and simultaneously as described in (1) above. The failed node becomes the island node for each of these restorations, and demands whose source or destination is the failed node are lost.

In a preferred embodiment, if the network of FIG. 2 is carrying a bi-directional demand between nodes one and seven on working path 1-5-6-7 and another bi-directional demand between nodes eight and three on working path 8-5-6-7-3, both of these use link 270, but the primary component of the working path 1-5-6-7 uses the link from left to right while the primary component of the working path 8-5-6-7-3 uses it from right to left. If link 270 fails, node five 210 detects the failure , so node five 210 becomes the DN and node six 220 becomes the IN for the restoration of the bi-directional demand on working path 1-5-6-7. The restoration path for working path 1-5-6-7 is therefore confined to island six 290. Node six 220 also detects the failure, so node six becomes the DN and node five 210 becomes the IN for the restoration of the bidirectional demand on working path 8-5-6-7-3. The restoration path for working path 8-5-6-7-3 is confined to island five 280. If node five 210 fails then node one perceives this as a failure of link (1,5) and node one becomes the DN for the restoration of the bi-directional demand between nodes one and seven. At the same time, node six 220 perceives the failure of node five 210 as the failure of link 270, and node six 220 becomes the DN for the restoration of the bidirectional demand between nodes eight and three. Node five is the IN for both of these operations, and therefore they are performed using restoration paths confined to island five 280.

Upon detection of a failure, the IRP carries out a coordinated set of message exchanges and cross-connect actions in order to reroute the affected traffic. Nodes in a restoration island perform different tasks depending on the location of the failure. Based on the role it plays in the restoration of a specific connection, a node is classified as an IN, a DN, a restoration entrance node, (“REN”) a restoration exit node (“RXN”) or a pass through node (“PN”). As indicated above, an IN is the island node for the restoration taking place. A node is a DN for restoration of a demand if it detects a perceived failure of a link that carries the working path of the primary component of that demand outbound from that node. A REN is the point at which the primary component of the demand being restored is detoured from its working path onto its restoration path. A RXN is the point at which the restoration path of the primary component rejoins the original working path. A node is designated PN if it is on the restoration path but is neither an REN nor an RXN. Since each node may carry many connections, its designation will vary from one connection to another. Moreover, a node can carry several designations for a specific connection.

With continued reference to our FIG. 2 example, with a perceived failure of link 270 in FIG. 2, the path designated for the restoration of the bidirectional connection carried on working path 1-5-6-7 is 5-2-3-7, which is confined to island six 290, and the path designated for the restoration of the bidirectional connection carried on working path 3-7-6-5-8 is 6-8, which is confined to island five. When link 270 fails, the primary component of the working path 1-5-6-7 is restored on the path 1-5-2-3-7, and the primary component of the working path 8-5-6-7-3 takes the path 3-7-6-8. The secondary components use these paths in the opposite directions. For the demand between nodes one and seven, node five 210 is the DN and the REN, node six 220 the IN, node seven the RXN and nodes two and three are PNs. For the demand between nodes three and eight, node six is the DN and the REN, node five the IN, node eight is the RXN and there are no PNs.

If on the other hand, node six fails, node five perceives a failure of link (5,6) 270 and restores the bi-directional connection between nodes one and seven as above. Node seven now perceives a failure of link (6,7) carrying the primary component of the bi-directional connection between nodes three and eight. Let us assume that the path designated for restoration of this connection in case of failure of link (6,7) is 3-2-5, which is confined to island six. The restored connection thus takes the path 3-2-5-8. For this restoration node seven is the DN, node six the IN, node three the REN, node five the RXN and node two a PN. Since both restoration paths avoid node six as required by the IRP, the operation succeeds in restoring the paths affected by the failure of this node, even though the node failure was perceived by each adjacent node as a link failure. This is an important feature of the invention: a fault is properly restored without knowing whether it is a link fault or a node fault. This feature is achieved through rule (2) of the preliminary part of the IRP.

The rules governing the IRP constrain the restoration routes, while still leaving flexibility to the network designer/operator in choosing the most desirable route. If several alternative restoration routes exist within an island for a given demand, quality-of-service constraints might dictate that the shortest path is chosen, or taking into account network congestion, a path might be selected to distribute the restored load evenly among the links in the island.

Once the restoration paths have been chosen, capacity must be reserved on each link for all demands whose restoration paths use that link in times of failure. The amount of restoration capacity that must be reserved on a link is determined from the chosen restoration paths and their required capacity. In the context of an optical network, the basic unit of capacity may correspond to the capacity of one wavelength channel, or some fraction of that capacity. The latter case would apply, for example, if several basic channels are time-division multiplexed onto one wavelength of a multi-wavelength optical transmission system. Assuming that each bi-directional demand requires a known number of units of bidirectional capacity, the same number of units of bidirectional restoration capacity must be available on the restoration path for that demand. Reserved capacity on a given link may be shared among several restoration paths using that link as long as the shared reserved capacity will not be needed to restore more than one connection at a time. Based on this condition, the required restoration capacity on a given link can be calculated using the following steps:

(1) Determine the total restoration capacity required on a given link for all demands whose restoration paths use that link when one node or link fails.

(2) Repeat this computation for each potential node or link failure, and choose the reserved restoration capacity for the given link to be the maximum of the required capacities found in step (1) for all potential failures.

(3) Repeat the restoration capacity calculation for each link in the network.

The actual determination of restoration path routing and capacity allocation can be done before the network is activated, as part of the preliminary part of the IRP, and/or by a network management system when the network is in operation. The latter approach is necessary to deal with changing traffic distributions and changing network topology. If modifications of restoration capacity allocation are to be made during network operation, the network must be designed with sufficient spare capacity so that it can be allocated to support restoration of new network demands. The required spare capacity would normally be estimated based on predicted changes in traffic distributions. Once restoration path routing and capacity allocation are determined, this information must be disseminated to network nodes to provide routing table and restoration protocol information needed for executing the fault recovery procedures.

Assuming that islands have been identified, restoration paths have been chosen, restoration capacity has been reserved, and routing table dissemination has been accomplished, the network is ready to respond to failures. Execution of restoration once a failure has been detected requires reconfiguring the cross connects along the restoration paths associated with each primary demand affected by the failure. This reconfiguration restores both the primary and secondary demands in opposite directions on the same restoration path. Thus, both primary and secondary demands are rerouted around the failure. Rerouting entails sending messages from the detecting node to all other nodes on the restoration path to inform them of the failure so that they can reconfigure their cross connects accordingly. This is coordinated during the real-time phase of the IRP. It is assumed that before a failure occurs the channels allocated for the network restoration are idle and are not yet cross-connected through the nodes to create the restoration path. It is also assumed that a signaling system exists in the network to carry the various messages between nodes that are required for routing table updating as well as real time execution of the IRP.

The signaling system could conveniently be implemented via communications software in the nodes and could use separate supervisory channels in the links, overhead embedded in the user data, or some other method of information transmission to carry the protocol messages. It is also assumed that procedures built into the software will continually monitor the status of the signaling system and react to any failures of its components, reconfiguring the signaling system and rerouting the signaling traffic if necessary, in order to maintain viable paths for IRP messages in the face of component failures. These communication procedures can be based on, but are not limited to, any currently used set of networking protocols, for example the Internet Protocol (IP). The precise means of communication in the signaling system are unimportant as long as they can convey the necessary information in a timely and reliable fashion.

In a preferred embodiment, the real time part of the IRP executes the following steps in response to a perceived link failure:

(1) For each bi-directional demand whose primary component is carried outbound on the link perceived to have failed, the DN consults its routing table and determines if the DN is the REN for restoration of that connection. If so the DN executes a two-way cross-connection, detouring the outbound primary connection from its working path onto its restoration path, and at the same time detouring the inbound secondary component from the restoration path onto the working path. The DN also multicasts restoration messages to all nodes in the island for this restoration, indicating that the restoration operation is being initiated, and providing enough information to allow the nodes on the restoration path to execute their functions under the IRP. For example, the information in the restoration message might consist of the identity of the DN, the failed link and the demand being restored. The remaining information needed by the other nodes in the island to effect restoration; e.g., the new settings of their cross-connects to route the restoration paths, would then reside in tables in those other nodes. If the DN is not the REN for the primary component in question it multicasts the restoration messages without changing its cross-connect settings.

(2) When a node receives a restoration message from a DN it determines whether it is required to participate in the restoration as an REN, an RXN or a PN.

a. If it is neither of these it does nothing.

b. If it is the REN for the restoration underway it consults its routing tables and executes a two-way cross-connection, detouring the outbound primary connection from its working path onto its restoration path, and detouring the inbound secondary component from the restoration path onto the working path.

c. If it is the RXN for the restoration underway it consults its routing tables and executes a two-way cross-connection, detouring the outbound secondary connection from its working path onto its restoration path, and detouring the inbound primary component from the restoration path onto the working path.

d. If it is a PN for the restoration underway, it consults its routing table and executes a bi-directional cross-connection to establish the desired restoration path in both directions through the node.

The IRP is designed to operate properly when a single element, either a link or a node has failed. However, it will also correctly restore multiple failures provided that the restoration resources required for each failure are mutually disjoint. For example, two node failures can be restored if the islands for these nodes do not intersect, and two link failures can be restored if the pair of islands used to restore one link failure does not intersect the pair used to restore the other. Moreover, the IRP can be modified to operate properly when certain predictable combinations of failures, known as “shared risk groups” (SRGs) occur simultaneously. For example, if two links share the same underground conduit along part of their length, then if that conduit is destroyed both will fail simultaneously, so that they should be treated as an SRG. A simple modification of the rules governing the determination of required restoration capacity on a given link will allow for the existence of SRGs. In step (1) of those rules (see above), the total restoration capacity required on a link must be determined for all demands Whose restoration paths use that link when one node or one link or one SRG fails. In step (2) of those rules, the computation must be repeated for each potential node or link or SRG failure.

While the above steps outline the principal operations of the IRP, a protocol that operates under realistic conditions must, as one of skill in the art would realize, deal with special situations which may violate some of the assumptions underlying the restoration procedures described above.

Some situations include, but are not limited to:

(1) Sufficient network capacity may not exist to ensure restoration of every link node or SRG failure. In that case only a subset of all demands or a subset of potential failures can be designated for restoration.

(2) The capacity allocated to restore a fault may be currently occupied by pre-emptable low priority traffic, violating the assumption that the restoration channels are idle prior to the failure. In order to ensure that traffic is not erroneously directed to the wrong destination, care must be taken to see that the reconfiguration operations are executed in proper sequence. Each PN on a restoration path must drop any pre-emptible traffic currently carried on the channels required for restoration before setting up the restoration path using these channels. One way of executing the restoration actions in proper sequence is by doing the restoration in two phases. In the first phase the DN multicasts a restoration message to all nodes in the island for this restoration, indicating that the restoration operation is being initiated, and providing enough information to allow the nodes on the restoration path to execute their functions under the IRP. Upon receiving a restoration message multicast from the DN for a failure being restored the REN (which may be the DN itself), the RXN and each PN on the restoration path releases the cross-connections for any pre-emptible traffic being carried on the channels needed for the restoration underway. Upon completion of the release, each node sends a confirmation message back to the DN. Upon receiving confirmation messages from all nodes on the restoration path, the DN knows that the restoration path is clear of all traffic. The second phase of the restoration then proceeds as in steps (1) and (2) of the real time part of the IRP described earlier.

(3) The restoration capacity allocated for the restoration in progress may be currently occupied by restored traffic from another concurrent fault. Thus, the assumption that only one fault occurs at a time has been violated. In this case, depending upon priorities, either the current or the previous restoration operation must be aborted. A related situation occurs when a fault occurs, and then a second fault occurs before restoration of the first fault is completed. If the two faults use some of the same restoration resources one of the two restorations must be aborted in favor of the one with higher priority.

(4) Only one direction of transmission on a link fails; e.g., one fiber in a bidirectional fiber pair fails, resulting in a partial link failure. Thus, the assumption of complete link failure has been violated. In this case, the node down stream on the failed fiber becomes the detecting node, initiating restoration of all bi-directional demands whose primary components are carried on the healthy fiber. This restoration is necessary because the working paths for the secondary components of these demands use the failed fiber, and thus both components of the affected demands must be switched to their restoration paths so that they continue to be routed in both directions over the same path. Since the other fiber is operational, the node upstream on the failed fiber is oblivious to the failure and therefore does not initiate restoration of the demands whose primary components were carried on the failed fiber. One way of dealing with this problem is for the detecting node (the node downstream on the failed fiber) to attempt to send a message on the link perceived to have failed, to the node at the other end of the failed link (even though the link may have failed in both directions), indicating that it has detected a failure on the incoming fiber. On receipt of this message, the upstream node designates itself a detecting node, and initiates restoration of all demands whose primary components are directed outbound on the failed fiber, as required. This diverts some connections from a healthy fiber, but is essential to satisfy the requirement that bidirectional demands are always routed in both directions on the same restoration path.

In addition to these special situations, it may be desirable in some cases to add features to the basic IRP to make it more reliable, flexible or efficient. These features might include but are not be limited to:

(1) acknowledgements of receipt of the various protocol messages and confirmations of cross-connect reconfigurations to ensure error-free operation,

(2) release of channels no longer used along a portion of a working path when a connection is detoured from that path to free up the channels for other uses,

(3) return of restored traffic to its working path after a fault is repaired, and release of the restoration channels.

(4) assignment of demands to different traffic classes based on desired restorability. For example, one class might be unprotected traffic (no restoration paths reserved), another might be fully protected (restoration paths reserved for all single link and node failures along the working path) and another might be partially protected (restoration paths reserved for some subset of all possible failures).

An important property of any restoration scheme is restoration time (“RT”), which is the sum of the time a node requires to detect a failure (“TF”), the time needed to reconfigure a cross connect, (“TXC”), and the time required to multicast a message from the detecting node to all nodes on the restoration paths for the affected traffic, including message processing, transmission and propagation times (“TD”); i.e., RT=TF+TD+TXC. This assumes that there is no pre-emptible traffic. With pre-emptible traffic an approximate expression for the restoration time is RT=TF+3TD+2TXC, since there is a three-way exchange of messages, and the cross-connects are reconfigured twice. While most of the components of RT are technology-dependent, the propagation time imposes an irreducible physical limitation determined by the geographic path length between the DN and the node which is farthest from it on a restoration path. Since these nodes are in the same island, they are usually close together geographically, which tends to keep RT small, as compared to the restoration time in a path protection scheme, which includes the message propagation time from a connection's source to its destination. A further advantage of this invention over path protection is that fewer restoration messages are required in the island restoration scheme, keeping the communication and processing overhead low.

As would be understood by one of ordinary skill in the art, variations of the IRP are possible. For example, in the case of restoration paths carrying pre-emptible traffic, the two components of a bi-directional demand being restored can be redirected along the restoration path as soon as the REN and RXN receive the restoration message from the detecting node, without waiting for confirmations that all PNs along the path have correctly released the cross-connections for the pre-emptible traffic. This significantly reduces the restoration time. However, in this case, there is a risk that the redirected traffic may be routed erroneously if all PNs have not reconfigured their cross-connections to set up the restoration path. Thus, special measures must be taken to block the rerouted traffic until the restoration path is correctly set up.

In operation, the island restoration protection scheme will be illustrated using the network graph depicted in FIG. 2. All demands for this network are bi-directional and their working paths and required capacities are presumed known before the preliminary part of the IRP is executed. The intersecting islands five 280 and six 290 for this network are outlined in FIG. 2. The remaining islands, which are not outlined in FIG. 2, are chosen to be minimal islands; i.e., each contains its island node, its incident links and a minimum number of additional links to ensure connectivity among the adjacent nodes if the island node fails. For example island eight consists of the node set {8,4,1,5,6, 7,9} and the link set {(4,8), (5,8), (6,8), (8,9), (1,4), (1,5), (5,6), (6,7), (7,9)}. Island 7 consists of the node set {7,3,2,6,8,9} and the link set {(3,7), (6,7), (7,9), (8,9), (2,3), (2,6), (6,8)}. This illustrates the fact that an island can be a sub-network of another island; island seven is a sub-network of island six. In the list of steps shown below, steps 1-3 are executed off-line and constitute the preliminary part of the IRP, involving calculations that assign restoration routes, pre-allocate capacity, and set up routing tables to prepare the network for fault restoration. Step 4 is executed upon the detection of a fault using the real time part of the IRP.

(1) Identify islands for each node. The islands shown in FIG. 2 were constructed using the island identification procedure described earlier.

(2) For every island in the network, determine restoration paths for each demand whose primary component is carried on a link incident to the island node. (Only demands whose primary components are directed toward the island node are restored in the given island.) Suppose that the network is carrying bi-directional demands whose primary components are routed on working paths as follows, requiring the indicated units of capacity: (a) 4-8-6 (2 units); (b) 1-5-6-7 (3 units); (c) 1-5-8 (1 unit); (d) 2-5 (1 unit); (e) 3-7-6-5-8 (1 unit).

For island five 280, restoration paths are chosen for perceived failures in links as indicated in Table I.

TABLE I
Restoration paths in Island Five

| Link | | | |
|---|---|---|---|
| failure | Primary connection | Restoration path | Restoration capacity |
| (1, 5) | 1-5-6-7 | 1-2-6 | 3 |
| (1, 5) | 1-5-8 | 1-4-8 | 1 |
| (2, 5) | 2-5 | 2-1-5 | 1 |
| (5, 6) | 3-7-6-5-8 | 6-8 | 1 |

There is no entry in Table I for link (5,8) because it carries no primary connections directed toward node five. As required by rule (2) of the preliminary part of the IRP, each restoration path excludes node five except that for connection 2-5, which terminates on that node. Tables II, III and IV show restoration paths for perceived failures of links in islands 6, 7 and 8 respectively. There are no restoration paths for islands 1, 2, 3, 4, 9 because there are no primary demands restored in these islands.

TABLE II
Restoration paths in Island Six

| Link | | | |
|---|---|---|---|
| failure | Primary connection | Restoration path | Restoration capacity |
| (5, 6) | 1-5-6-7 | 5-2-3-7 | 3 |
| (6, 7) | 3-7-6-5-8 | 3-2-5 | 1 |
| (6, 8) | 4-8-6 | 8-5-6 | 2 |

TABLE III
Restoration paths in Island Seven

| Link | | | |
|---|---|---|---|
| failure | Primary connection | Restoration path | Restoration capacity |
| (3, 7) | 3-7-6-5-8 | 3-2-6-8 | 1 |
| (6, 7) | 1-5-6-7 | 6-2-3-7 | 3 |

TABLE IV
Restoration paths in Island Eight

| Link | | | |
|---|---|---|---|
| failure | Primary connection | Restoration path | Restoration capacity |
| (4,8) | 4-8-6 | 4-1-5-6 | 2 |
| (5,8) | 1-5-8 | 1-4-8 | 1 |
| (5,8) | 3-7-6-5-8 | 6-8 | 1 |

(3) From the restoration paths and their required capacities, determine all link capacities that must be reserved for restoration. Table V gives the bi-directional link capacities that must be reserved. Each of the first eight rows of the table gives the capacity that must be available on each link to restore a specific link failure, and the island in which the failure is restored. For example, in row L (5,6), column (6,8) indicates that 1 unit of capacity must be reserved on link (6,8) to restore a failure of link (5,6), with the failure being restored in island five. In the row L (6,7), column (2,3) indicates that 1 unit of capacity must be reserved on link (2,3) with the restoration being executed in island six, and an additional 3 units must be reserved on the same link with the restoration being executed in island seven, so that a total of 4 units of capacity must be reserved on link (2,3) to respond to a failure of link (6,7). The link capacity required for a given node failure is found as the sum of the capacities required on that link to restored all perceived link failures restored in that node's island. These values are given in rows N 5 through N 8 of Table V. For example, column (2,3) of row N6 shows that 4 units of capacity must be reserved on link (2,3) to restore a complete failure of node six. The last row of Table V gives the total capacity that must be allocated on each link for restoration of any single link or node failure. This allocation is found by taking the maximum of all entries in the column for the link in question. For example, column (2,6) in the last row of Table V shows that 4 units of capacity must be reserved on link (2,6) to restore any single link or node failure. This capacity is shared by the restoration paths reserved for perceived failures of links (1,5), (3,7) and (6,7).

TABLE V
Link capacity reserved for link or node failure restoration

| | Restoration Links | | | | | | | | | | |
|---|---|---|---|---|---|---|---|---|---|---|---|
| Failure | (1,2) | (1,4) | (1,5) | (2,3) | (2,5) | (2,6) | (3,7) | (4,8) | (5,6) | (5,8) | (6,8) |
| L | 3:15 | 1:15 | | | | 3:15 | | 1:15 | | | |
| (1,5) | | | | | | | | | | | |
| L | 1:15 | | 1:15 | | | | | | | | |
| (2,5) | | | | | | | | | | | |
| L | | | | 1:17 | | 1:17 | | | | | 1:17 |
| (3,7) | | | | | | | | | | | |
| L | | 2:18 | 2:18 | | | | | | 2:18 | | |
| (4,8) | | | | | | | | | | | |
| L | | | | 3:16 | 3:16 | | 3:16 | | | | 1:15 |
| (5,6) | | | | | | | | | | | |
| L | | 1:18 | | | | | | 1:18 | | | 1:18 |
| (5,8) | | | | | | | | | | | |
| L | | | | 1:16 + | 1:16 | 3:17 | 3:17 | | | | |
| (6,7) | | | | 3:17 | | | | | | | |
| L | | | | | | | | | 2:16 | 2:16 | |
| (6,8) | | | | | | | | | | | |
| N 5 | 4 | 1 | 1 | 0 | 0 | 3 | 0 | 1 | 0 | 0 | 1 |
| N 6 | 0 | 0 | 0 | 4 | 4 | | 3 | 0 | 2 | 2 | 0 |
| N 7 | 0 | 0 | 0 | 4 | 0 | 4 | 3 | 0 | 0 | 0 | 1 |
| N 8 | 0 | 3 | 2 | 0 | 0 | 0 | 0 | 1 | 2 | | 1 |
| Total | 4 | 3 | 2 | 4 | 4 | 4 | 3 | 1 | 2 | 2 | 1 |

(4) Respond to each perceived link failure by executing the IRP for that link. As a first example, consider the failure of link (5,6) 270, in FIG. 2. Node five 210 senses the failure and becomes the DN and the REN for the primary connection 1-5-6-7, which is restored in island six on path 5-2-3-7 using 3 units of capacity. Acting as the REN, node five consults its routing tables and reconfigures its switch to provide a two-way cross-connection between link (1,5) and link (5,2) for the bi-directional channels carrying the 3 units of capacity for the primary and secondary components of the restored connection traversing the node in opposite directions. Node five acting as the DN also multicasts a restoration message to all other nodes in island six, i.e., nodes 2,3, 6,7,8,9. Upon receiving the restoration message, nodes two and three, acting as PNs, and node seven acting as the RXN consult their tables and perform the necessary bi-directional cross-connections completing the restoration. At the same time node six 220 senses the failure and becomes the DN and the REN for the primary connection 3-7-6-5-8, which is restored on path 6-8 in island five using one unit of capacity. Acting as the REN, node six reconfigures its switch to provide a two-way cross-connection between link (6,7) and link (6,8) for the bi-directional channel carrying 1 unit of capacity for the primary and secondary components of the restored connection traversing the node in opposite directions. Node six acting as the DN also multicasts a restoration message to all other nodes in island five; i.e., nodes 1,2,4,5,8. Upon receiving the restoration message, node eight acting as the RXN performs the necessary bi-directional cross-connections completing the restoration.

As a second example, consider the failure of node seven. In this case nodes three and six sense perceived failures of links (3,7) and (6,7) respectively. (Node 9 may sense a perceived failure of link (7,9), but it plays no role in restoration since it carries no working path.) Node three becomes the DN and the REN for the primary connection 3-7-6-5-8, which is restored in island seven on path 3-2-6-8 using 1 unit of capacity and employing techniques identical to those described in the first example. Node six becomes the DN and the REN for the primary connection 1-5-6-7, whose restoration is attempted in island seven on path 6-2-3-7 using 3 units of capacity, employing techniques identical to those described in the first example. However, in this case the connection being restored terminates on the failed node, which is the RXN for this restoration, and therefore the connection cannot be restored. Despite the fact that restoration is impossible for this connection when node seven fails, the IRP makes the attempt, since node six has no way of knowing whether the actual fault is due to failure of link (6,7) or node seven. If the element that failed had actually been the link (6,7), the identical procedure would have been followed, and restoration would have been successful.

It should be noted that the original assumption that all demands were bidirectional is easily relaxed. If there are both unidirectional and bidirectional demands in the network, the former are always designated as primary, with an indication in the routing tables that they have no secondary counterpart. Then, in the various steps of the restoration computation and execution, no provision is made for a secondary demand. Thus, no restoration capacity is reserved, and no actions are taken in the IRP to restore the secondary demand.

While the above example dealt with single failures only, it is possible to restore certain combinations of simultaneous failures provided that the restoration resources required for each failure are disjoint. For example, Table V indicates that a failure of link (2,5) is restored using links (1,2) and (1,5), while a failure of link (5,8) is restored using links (1,4), (4,8) and (6,8). Since these two sets of links are disjoint, both link failures can be restored simultaneously. Furthermore, it may be that links (2,5) and (5,8) leave node five in the same conduit before branching out toward nodes two and eight. In that case those two links should be considered as an SRG. Since the links are simultaneously restorable, the SRG is restorable.

It was assumed thus far that restoration routes and capacity allocations are determined for a network with a given fixed topology and a known fixed set of demands. This is useful in the initial stages of planning a network with a known traffic demand. The goal in this case is to find the optimum restoration paths needed by the network to recover from all restorable link and node failures. However, in the course of operating a network, some existing demands will be released and new ones will be activated, that is, the network traffic will be varying dynamically.

When dealing with a dynamic traffic environment, the pre-computed part of the island restoration procedure can be modified as follows. First, based on an estimated demand distribution, restoration capacity is pre-allocated as before. At this point an allowance for the expected random fluctuations in the traffic may be made by adding some additional capacity. Once this pre-allocation is made it remains fixed, even though the demands vary with time. Now, each time there is a request for a new connection, the network will accept or deny (block) the request based on the availability of a suitable working path, which must be restorable using the existing restoration capacity. Restorability is determined by first selecting a tentative working path for the demand, and then checking its restorability under the constraints of the island restoration architecture. The check is performed by following the restoration path routing procedure described above for each link traversed by the working path. If it is possible to find a restoration path with the necessary free or sharable capacity in each island, then the request is accepted. Otherwise, it is blocked.

In the dynamic case, network performance would typically be measured in terms of connection blocking probability as a function of offered traffic. There are many ways of varying the basic restoration technique to produce changes in performance. Some possibilities include, but are not limited to the following:

(1) The amount of reserved restoration capacity and its distribution within the network can be varied to optimize blocking performance.

(2) The initially chosen tentative working path for a new demand can be modified if it cannot be restored using the existing restoration capacity.

(3) Different levels of protection might be considered for different traffic classes. For example, protection against both node and link failures might be offered to one class, while only link protection offered to another class, and no protection at all provided to a third class.

(4) To control network performance, an admission control strategy can be used wherein certain connection requests that require too much network capacity are rejected even though the network could accommodate them. For example, a request for a very high capacity connection might be rejected because it would create a bottleneck that would block subsequent requests for many smaller connections.

(5) Finally, the reserved restoration capacity might be varied in response to changes in traffic distribution, link capacities or network topology.

While the invention has been particularly shown and described with reference to preferred embodiments thereof, it will be understood by those skilled in the art that various changes in form and details may be made therein without departing from the spirit and scope of the invention.

What is claimed is:

1. A system for communication restoration in a communication network upon detection of a perceived fault, the system comprising:
a plurality of communication nodes, each node being connected to at least one other node by a communication link;
a plurality of communication links, each link supporting at least one channel in each direction, the channel supported by a transmission facility in each direction on the link;
a plurality of communication devices of which at least two of the devices are connected to or incorporated in respective nodes;
at least one node acting as a source of a communication connection for the device associated with the node, and at least one node acting as a destination of a communication connection for the device associated with the node;
at least two of the nodes containing controllable cross-connects, the cross-connects having at least two input ports and two output ports, the channels on the node's incident links connected to the input ports and the output ports of the cross-connects;
at least two of the nodes containing restoration subsystems for restoring communication connections upon perceived link failure;
at least one node triggers a fault restoration procedure once that node detects the perceived link failure;
wherein the subsystem for restoring communication connections: (1) detects perceived faults on the links attached to its nodes, (2) stores information related to fault restoration, and (3) exchanges information between nodes for executing fault restoration procedures, and
wherein the fault restoration procedures: (1) reconfigure the controllable cross-connects to detour communication connections affected by the perceived fault using predetermined restoration paths on links confined to a prescribed island associated with each perceived fault, the island being a prescribed sub-network of the communication network containing the perceived fault and (2) restore communication connections carried by the link perceived to have failed without the restoration subsystem in the node detecting the perceived link fault requiring knowledge of whether an actual fault is on the link or the node connected to the other end of the link.

2. The system as in claim 1 wherein the transmission facilities comprise optical fibers.

3. The system as in claim 1 wherein the cross-connects comprise optical switches.

4. The system as in claim 1 wherein the cross-connects comprise electronic switches.

5. The system as in claim 1 wherein the fault restoration system selectively restores at least one communication connection carried on the link perceived to have failed, but less than all communication connections on that link.

6. The system as in claim 1 wherein the restoration subsystem in a node detects perceived faults on a link incident on that node.

7. The system as in claim 6 wherein fault recovery is accomplished without knowledge of whether a perceived fault is on a link or a node attached to that link.

8. The system as in claim 5 wherein the restoration system in a node detects perceived faults on a link through loss of signal.

9. The system as in claim 5 wherein the restoration system in a node detects perceived faults on a link through deterioration of signal quality.

10. The system as in claim 5 wherein the restoration system in a node detects perceived faults on a link through signals received on the failed link.

11. The system as in claim 6 wherein the fault restoration system detects faults on fewer than all the links in the network or fewer than all the nodes in the network.

12. The system as in claim 1 wherein the predetermined restoration paths comprise pre-allocated restoration communication channels.

13. The system as in claim 12 wherein more than one predetermined restoration path shares pre-allocated restoration communication channels.

14. The system as in claim 13 wherein the pre-allocated restoration communication channels are available for active communication connections when the pre-allocated restoration communication channels are not needed for fault restoration.

15. The system as in claim 14 wherein active communication connections are pre-empted by restored communication connections when the pre-allocated restoration channels are needed for restoration.

16. The system as in claim 1 wherein each link has a reserved capacity, the reserved capacity equal to or greater than the total restoration capacity required on the link for all demands whose predetermined restoration paths use that link when any single node, link or shared risk group designated for fault restoration, fails.

17. A method for communication restoration upon detection of a perceived fault in a communication network having a plurality of communication nodes, each node being connected to at least one other node by a communication link, at least two communication nodes contain a system for detecting perceived faults on communication links attached to the communication nodes, for storing information related to fault restoration, and for exchanging information between nodes for executing fault restoration procedures; a plurality of communication links, each link supporting at least one communication channel in each direction, the communication channel supported by a transmission facility in each direction on the link; and a plurality of communication devices of which at least one device is connected to or incorporated in a node, behaving as a source of a communication connection and at least one device is connected to or incorporated in a node, behaving as a destination of a communication connection; wherein at least two nodes contain a controllable cross-connect with at least two input ports and two output ports, the communication channels connecting to the input ports and the output ports of the controllable cross-connects, comprising the steps of:
pre-determining restoration paths on links confined to a prescribed island for each perceived link fault;
triggering fault restoration once at least one node detects the perceived link fault;
re-configuring cross-connects to detour communication connections affected by the perceived link fault along the predetermined restoration paths confined to the prescribed island of the perceived link fault; and,
restoring some or all communication connections carried by the link perceived to have failed, without the node detecting the perceived link fault having knowledge of whether an actual fault is on the link or the node attached to the other end of the link.

18. The method as in claim 17, wherein the triggering step selectively applies to fewer than all the links or fewer than all the nodes in the network.

19. The method as in claim 17, wherein at least some communication connections are bi-directional, each bi-directional connection having two uni-directional connections, the two unidirectional connections traversing the same path through the network in opposite directions.

20. The method as in claim 19, wherein the triggering step further comprises initiating fault restoration only for preselected unidirectional components of the bi-directional connections traversing the failed link.

21. The method as in claim 20, wherein the initiating step further comprises restoring both unidirectional components of a bi-directional connection along the same restoration path in opposing directions.

22. The method as in claim 17, wherein, when a node detects a perceived link fault the actual fault may be on the link or the node attached to the other end of the link.

23. The method as in claim 17, wherein each communication link has a reserved capacity equal to or greater than the total restoration capacity required on the link for all demands whose predetermined restoration paths use that link when any single node, link or shared risk group designated for fault restoration, fails.

24. A method for fault restoration of a communication connection upon detection of a perceived fault in a communication network having a set of nodes, at least one node being a source node for a communication connection and at least one node being a destination node for a communication connection, at least two nodes containing a controllable cross-connect and a set of links connecting the nodes, comprising the steps of:
identifying islands of nodes and links surrounding a node, an island node, where communication connections designated for restoration in that island upon perceived fault detection, are restored on restoration paths confined to the island surrounding the island node,
storing in routing tables in the nodes participating in restoration of the perceived fault, a restoration subsystem necessary to restore each communication connection disrupted by the perceived fault on a predetermined restoration path, each restoration path having required capacity to support the restored communication connection;
reserving the required capacity on each link for each predetermined restoration path using that link in the event of an actual fault; and,
restoring a communication connection upon detection of a perceived link fault by reconfiguring the cross-connects according to the stored routing tables wherein the restoring step reconfigures without the system in a node detecting the perceived link fault having knowledge of whether the actual fault is on the link or the node attached to the other end of the link.

25. A method as in claim 24, wherein, when a node detects the perceived link fault the actual fault may be on the link or the node attached to the other end of the link.

26. A method as in claim 24, wherein the communication connection comprises at least one of a unidirectional connection and a bi-directional connection, the bi-directional connection comprising two unidirectional connections.

27. A method as in claim 26, wherein the two unidirectional connections of any bi-directional connection affected by the actual fault are restored on the same restoration path in opposite directions.

28. A method as in claim 24, wherein the restoring step further comprises:
detouring communication connections affected by the perceived fault according to predetermining restoration paths stored in the routing tables of the nodes participating in restoration, the restoration paths confined to an island surrounding the perceived fault.

29. A method as in claim 28, wherein the restoring step further comprises:
restoring communication connections carried by the link perceived to have failed without the node detecting the perceived link fault having knowledge of whether the actual fault is on the link or the node attached to the other end of the link.

30. A method as in claim 29, wherein, when a node detects the perceived link fault the actual fault may be on the link or the node attached to the other end of the link.
